(19) United States
(12) Patent Application Publication
(10) Pub. No.: US 2014/0043820 A1
(43) Pub. Date: Feb. 13, 2014

(54) BULB LAMP STRUCTURE

(71) Applicants: Zhi-Ting Ye, Zaociao Township (TW); Ming-Chuan Lin, Taichung City (TW); Ping-Yeng Chen, Taichung City (TW); Chang-Wei Yu, Caotun Township (TW)

(72) Inventors: Zhi-Ting Ye, Zaociao Township (TW); Ming-Chuan Lin, Taichung City (TW); Ping-Yeng Chen, Taichung City (TW); Chang-Wei Yu, Caotun Township (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/592,889

(22) Filed: Aug. 23, 2012

(30) Foreign Application Priority Data
Aug. 8, 2012 (TW) 101128634

(51) Int. Cl. F21V 11/02; F21V 7/00

(52) U.S. Cl. 362/291

(57) ABSTRACT

A bulb lamp structure includes a light source, a housing, an optical film and a lamp cover. The housing is used to accommodate the light source. The housing has an opening portion. The optical film is disposed on the opening portion and has a curve surface. The lamp cover is detachably assembled on the housing. The optical film is disposed between the light source and the lamp cover.

This application claims the benefit of Taiwan application Serial No. 101128634, filed Aug. 8, 2012, the subject matter of which is incorporated herein by reference.

### BACKGROUND OF THE INVENTION

1. Field of the Invention

The invention relates in general to a lamp, and more particularly to a bulb lamp structure.

2. Description of the Related Art

Tungsten wire bulb is used as a light source in a conventional lamp.

In recent years, in order to meet the requirements in terms of environmental conservation and power saving, the light emitting diode is gradually used as light source of the lamp. The light emitting diode, being a high-directional light source, has a divergence angle smaller than 180 degrees. Thus, the conventional bulb lamp structure must be modified to increase the divergence angle to meet the requirement of wide angle.

### SUMMARY OF THE INVENTION

The invention is directed to a bulb lamp structure, which includes an optical film to change the light divergence angle, so as to meet the requirement of wide angle.

According to an embodiment of the present invention, a bulb lamp structure including a light source, a housing, an optical film and a lamp cover is disclosed. The housing is used to accommodate the light source. The housing has an opening portion. The optical film is disposed on the opening portion and has a curve surface. The lamp cover is detachably assembled on the housing. The optical film is disposed between the light source and the lamp cover.

The above and other contents of the invention will become better understood with regard to the following detailed description of the preferred but non-limiting embodiments. The following description is made with reference to the accompanying drawings.

### BRIEF DESCRIPTION OF THE DRAWINGS

FIG. 1 shows a schematic diagram of a bulb lamp structure according to the first embodiment of the invention;

FIG. 2 shows a schematic diagram of a bulb lamp structure according to the second embodiment of the invention;

FIG. 3 shows a schematic diagram of a bulb lamp structure according to the third embodiment of the invention;

FIG. 4 shows a top view of an optical film according to an embodiment of the invention;

FIGS. 5A˜5D respectively show partial cross-sectional views along a cross-sectional line I-I of the optical film of FIG. 4.

### DETAILED DESCRIPTION OF THE INVENTION

The bulb lamp according to the present invention is modified to meet the requirement of wide angle by providing an optical film with diffusion and/or reflection function to change the light divergence angle. Normally, the bulb lamp using light emitting diodes as the light source has a divergence angle smaller than 180 degrees. In the present embodiments, a diffuser or a reflector is used in the bulb lamp to diffuse the light forward and reflect the light laterally and backward. Accordingly, in the embodiments, the light divergence angle of the LED is increased from an angle smaller than 180 degrees to an angle greater than 180 degrees to meet the requirement of wide angle.

A number of embodiments are disclosed below for elaborating the invention. However, the embodiments of the invention are for detailed descriptions only, not for limiting the scope of protection of the invention.

### First Embodiment

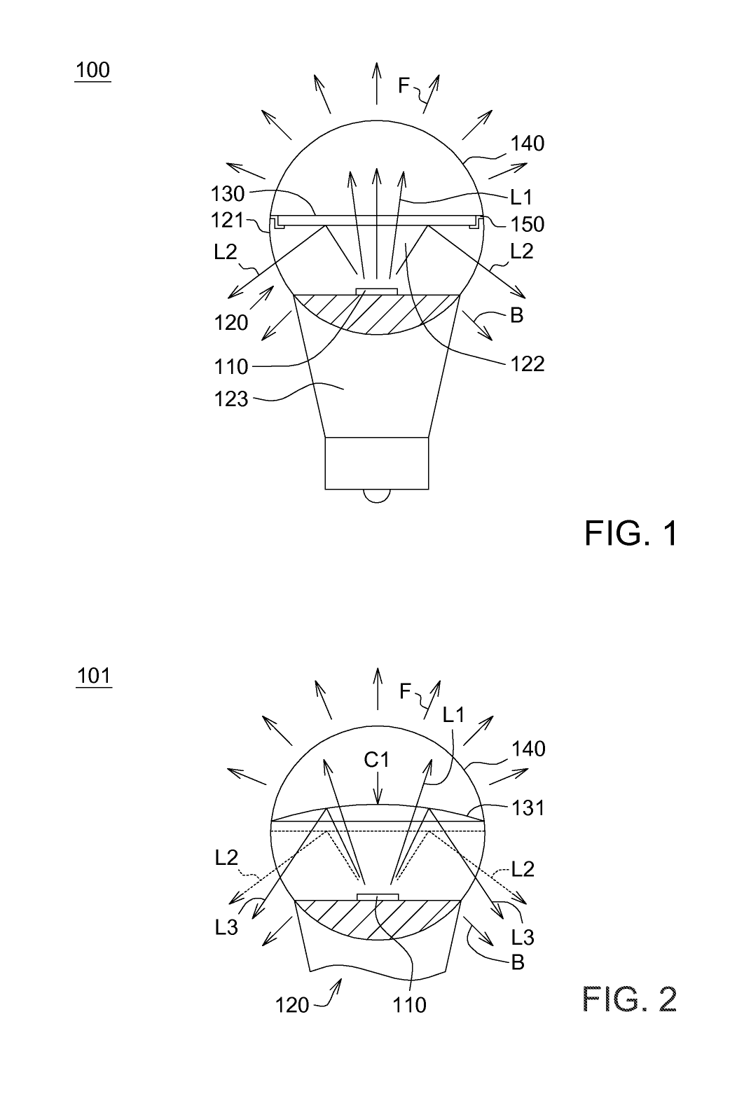

Referring to FIG. 1, a schematic diagram of a bulb lamp structure 100 according to an embodiment of the invention is shown. The bulb lamp structure 100 includes a light source 110, a housing 120, an optical film 130 and a lamp cover 140. The lamp cover 140 is detachably assembled on the housing 120 and is located right above the light source 110. Preferably but not restrictively, the lamp cover 140 and the housing 120 are assembled as a light permeable sphere for accommodating the light source 110, and the lamp cover 140 and the housing 120 are engaged together around the opening portion 122 by a spiral locking structure (not illustrated) for example, such that the lamp cover 140 is fixed on the opening portion 122. Besides, the housing 120 has an engaging mechanism 150, such as a hook or a recess, around the opening portion 122 to fix the optical film 130 on the housing 120.

In an embodiment, the housing 120 has a base 123 used for fixing the light source 110 and transferring the heat generated by the light source 110 outward. The light source 110 may be light emitting diode or other solid state light emitting semiconductor element.

The optical film 130 is disposed between the lamp cover 140 and the light source 110 for light diffusion and reflection. The optical film 130 may be a diffuser, a reflector or an optical film having diffusion and/or reflection functions. In an embodiment, the transmittance of the optical film 130 is greater than 80% for example, and less than 20% of the light is reflected by the optical film 130.

As indicated in FIG. 1, most of the light L1 with small emitting angle emitted by the light source 110 and directed towards the opening portion 122 passes through the optical film 130 and the lamp cover 140 sequentially to form a forward light F. In addition, most of the light L2 with large emitting angle emitted by the light source 110 and directed towards the opening portion 122 is reflected by the optical film 130 to pass through the housing 120 by the transparent zone 121 to be emitted to the rear of the bulb 100 to form a backward light B.

In the first embodiment, the light distribution of the bulb 100 may be controlled by adjusting the proportion between the forward light F and the backward light B through the optical film 130. In addition, the light divergence angle of the LED is increased from an angle smaller than 180 degrees to an angle greater than 180 degrees to meet the requirement of wide angle.

### Second Embodiment

Referring to FIG. 2, a schematic diagram of a bulb lamp structure 101 according to the second embodiment of the invention is shown. The similarities between the second embodiment and the first embodiment are not repeated, and their difference lies in that the optical film 131 has a curve surface C1 protruded towards the lamp cover 140. The curve surface C1 may change the emitting angle of the backward light B. As indicated in FIG. 2, the light L2 emitted towards the rear of the bulb 100 in the first embodiment is denoted by dotted lines, and the light L3 emitted towards the rear of bulb 101 in the second embodiment is denoted by solid lines. The emitting angle of the light L3 reflected by the optical film 131 is increased to 240 degrees or more from 220 degrees for example, such that the emitting angle of the backward light B is changed. In addition, the emitting angle of the forward light F is also varied with the curvature radius of the curve surface C1. In an embodiment, the curvature radius of the curve surface C1 is for example such as between 5˜1000 mm.

The optical film 131 is disposed between the lamp cover 140 and the light source 110. In the second embodiment, the optical film 131 may be exemplarily fixed on the housing 120 by the engaging mechanism 150 of the first embodiment.

### Third Embodiment

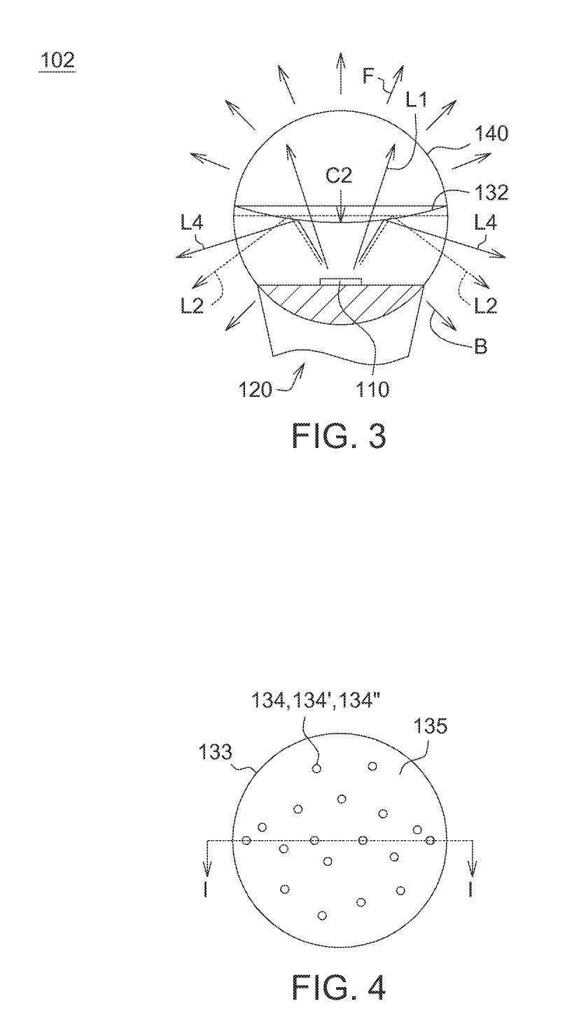

Referring to FIG. 3, a schematic diagram of a bulb lamp structure 102 according to the third embodiment of the invention is shown. The similarities between the third embodiment and the first embodiment are not repeated, and their difference lies in that the optical film 132 in the third embodiment has a curve surface C2 protruded towards the light source 110. The curve surface C2 may change the emitting angle of the backward light B. As indicated in FIG. 3, the light L2 emitted towards the rear of the bulb 100 in the first embodiment is denoted by dotted lines, and the light L4 emitted towards the rear of ball bulb 102 in the third embodiment is denoted by solid lines. The emitting angle of the light L4 reflected by the optical film 132 is for example decreased to 200 degrees or less from 220 degrees, such that the emitting angle of the backward light B is changed. In addition, the emitting angle of the forward light F may vary with the curvature radius of the curve surface C2. In an embodiment, the curvature radius of the curve surface C2 is for example such as between 5˜1000 mm.

The optical film 132 is disposed between the lamp cover 140 and the light source 110. In the third embodiment, the optical film 132 may be exemplarily fixed on the housing 120 by the engaging mechanism 150 of the first embodiment.

### Fourth Embodiment

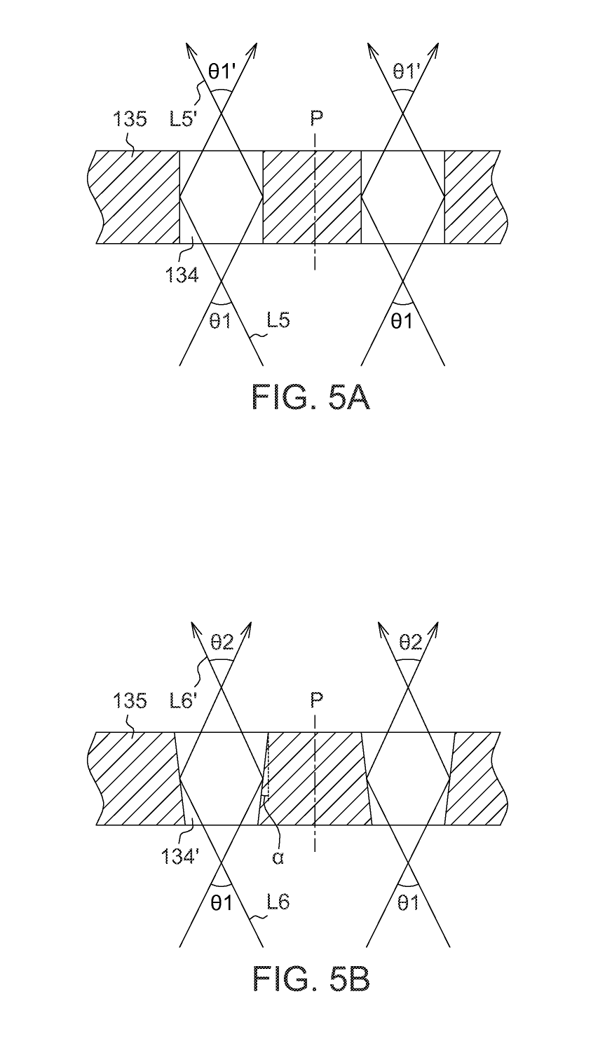

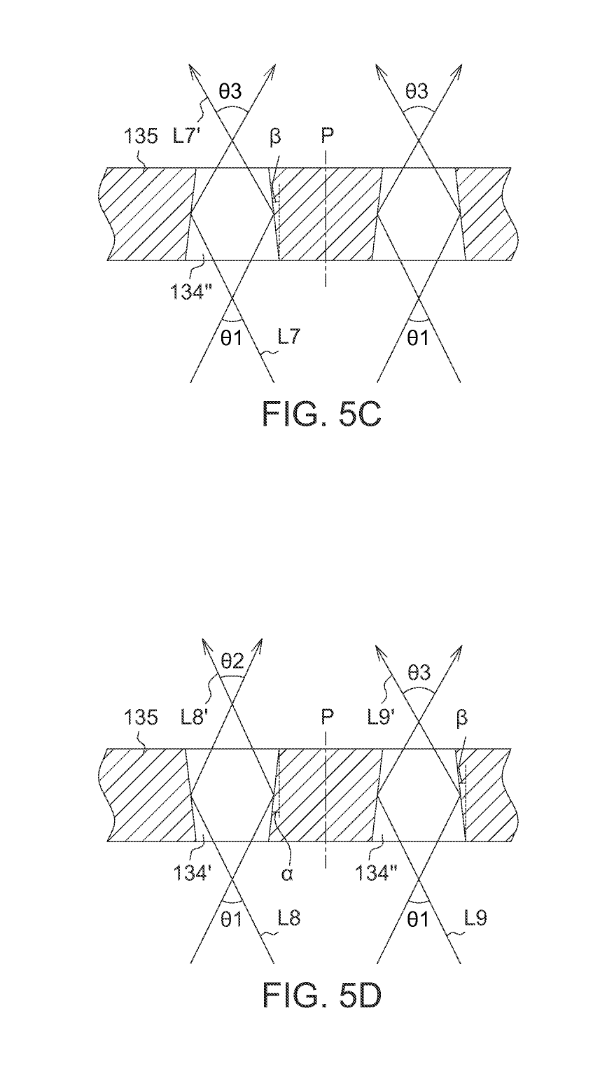

Referring to FIG. 4, a top view of an optical film 133 according to an embodiment of the invention is shown. The optical film 133 has a plurality of holes 134, 134′ and 134″ used for controlling the diffusion and the reflection. As indicated in FIG. 5A˜5D, the hole 134 is for example a cylindrical hole, and the holes 134′ and 134″ are for example conic holes. The following elaboration is exemplified by the holes 134 firstly.

The hole 134 is a light permeable region for allowing the light to pass through the optical film 133 to form a forward light. The non-hollowed region 135 is a reflective region for reflecting the light to form a backward light B. Density of the forward light F can be amplified by for example increasing the quantity or the size of the holes 134. Thus, the light diffusion and reflection can be modified by controlling the area ratio between the holes 134 region and the non-hollowed region 135 on the optical film 133. In an embodiment, the area ratio between the holes 134 region and the non-hollowed region 135 is for example between 0.3˜0.7.

The arrangement and density of the holes 134 would not be limited herein, and the area of the holes 134 may also be modified in accordance with the requirement. For example, the diameter of the holes 134 is between 0.2˜2 mm. In addition, the thickness of the optical film 133 is for example between 0.2˜5 mm.

The optical film 133 of the fourth embodiment may be applied to the bulb lamp structure 100 of the first embodiment, the bulb lamp structure 101 of the second embodiment or the bulb lamp structure 102 of the third embodiment. In other words, the optical film 133 of the fourth embodiment may be realized by a planar surface or a curve surface C1 protruded towards the lamp cover 140 or a curve surface C2 protruded towards the light source 110.

Referring to FIG. 5A˜5D, partial cross-sectional views along a cross-sectional line I-I of the optical film 133 of FIG. 4 are respectively shown. As indicated in FIG. 5A, the hole 134 is for example a cylindrical hole, and the inner wall of the hole 134 and the center line P of the holes in the normal direction are for example substantially parallel to each other. Meanwhile, two incident lights L5 are reflected by the inner wall of the hole 134 to be emitted outwards. The angle θ1 between the two incident lights L5 and the angle θ1′ between the two emitted light L5′ are substantially the same. As indicated in FIG. 5B, the hole 134′ is for example a conic hole with an top opening wider than a bottom opening. An angle α is formed between the inner wall of the hole 134′ and the center line of P of the hole in the norm direction. The two incident lights L6 are reflected by the inner wall of the hole 134′, and the angle θ1 between the two incident lights L6 is larger than the angle θ2 between the two emitted light L6′. Thus, the light emitting direction may be controlled by changing the angle α. As indicated in FIG. 5C, the hole 134″ is for example a conic hole with an top opening narrower than a bottom opening, which is opposite configuration to the hole 134′ of FIG. 5B. The two incident lights L7 are reflected by the inner wall of the hole 134″, and the angle θ1 between the two incident lights L7 is smaller than the angle θ3 between the two emitted light L7′. Thus, the light emitting direction may be controlled by changing the angle β. As indicated in FIG. 5D, the two holes 134′ and 134″ are for example two conic holes disposed in opposite directions. As disclosed in the elaboration of FIGS. 5B and 5C, the angle θ1 between the two incident lights L8 into the hole 134′ is greater than the angle θ2 of the two emitted lights L8′; the angle θ1 between the two incident lights L9 into the another hole 134″ is smaller than the angle θ3 between the two emitted lights L9″. Thus, the light emitting direction can be controlled by changing the disposition directions of the holes 134′ and 134″.

In an embodiment, the angles α and β in the above conic holes are for example between 3˜45 degrees. Part of the light can be reflected by the inner wall of the hole, such as the hole 134″ for example with an top opening narrower than a bottom opening of FIG. 5C, to be emitted backwards. Accordingly, the reflective direction of the light L2 can be controlled by the angle β to change the light divergence angle of the backward light B.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A bulb lamp structure, comprising:
a light source;
a housing accommodating the light source and comprising an opening portion;
an optical film disposed on the opening portion and comprising a curve surface; and
a lamp cover detachably assembled on the housing, wherein the optical film is disposed between the light source and the lamp cover.

2. The bulb lamp structure according to claim 1, wherein the curve surface comprises a curvature radius between 5˜1000 mm.

3. The bulb lamp structure according to claim 1, wherein the optical film is a diffuser or a reflector.

4. The bulb lamp structure according to claim 1, wherein the curve surface is protruded towards the light source.

5. The bulb lamp structure according to claim 1, wherein the curve surface is protruded towards the lamp cover.

6. The bulb lamp structure according to claim 1, wherein the optical film has a plurality of holes.

7. The bulb lamp structure according to claim 6, wherein each of the holes comprises an inner wall and a center line to provide an angle between 3˜45 degrees between the inner wall and the center line.

8. The bulb lamp structure according to claim 6, wherein the optical film has a non-hollowed region to provide an area ratio between 0.3˜0.7 between the holes region and the non-hollowed region.

9. The bulb lamp structure according to claim 6, wherein each of the holes has a diameter between 0.2˜2 mm.

10. The bulb lamp structure according to claim 1, wherein the housing has an engaging mechanism disposed around the opening portion to fix the optical film.
